(19) United States
(12) Patent Application Publication
(10) Pub. No.: US 2004/0119988 A1
(43) Pub. Date: Jun. 24, 2004

(54) System and method for measuring concentricity of laser to cap

(75) Inventors: John Chen, Rowland Heights, CA (US); Chun Lei, Los Gatos, CA (US); Robert Shih, Arcadia, CA (US); Hongyu Deng, Arcadia, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(73) Assignee: FINISAR CORPORATION

(21) Appl. No.: 10/693,773

(22) Filed: Oct. 24, 2003

Related U.S. Application Data
(60) Provisional application No. 60/422,069, filed on Oct. 28, 2002.
(60) Provisional application No. 60/423,967, filed on Nov. 4, 2002.

(51) Int. Cl. H04N 7/18; H04N 9/47; G01B 11/14

(52) U.S. Cl. 356/615; 348/86

(57) ABSTRACT

A device and method is disclosed for passively checking the concentricity measurement of optical components in an optical assembly. The optical assembly includes a package for a photonic device which has a header and a lens cap having an integrated lens. The photonic device is mounted to the header. A display system can be used to view the photonic device through the lens of the cap. Using a camera with a high magnification lens integrated into the display system, the alignment between the photonic device and the lens in the cap is measured.

### CROSS-REFERENCE TO RELATED APPLICATIONS

The present application claims priority to and the benefit of U.S. Provisional Patent Applications No. 60/422,069, filed on Oct. 28, 2002, and entitled “Photonic Device Package with Aligned Lens Cap”, and 60/423,967, filed on Nov. 4, 2002 and entitled “System and Method for Measuring Concentricity of Laser to Cap”, both of which are incorporated herein by reference in their entireties.

### BACKGROUND OF THE INVENTION

1. The Field of the Invention

The present invention relates generally to the packaging of photonic devices, such as lasers or photo detectors. More particularly, the present invention relates to measuring alignment characteristics of a lens in a cap with a photonic device in an optoelectronic device package.

2. The Relevant Technology

Referring to FIG. 1, a common package design 100 for a photonic device 104, such as a laser, includes a header 102, such as a TO header, and a cap 112 with a flat window 114 for coupling light between package 100 and at least one other optical element, such as an optical fiber. Header 102 typically includes pins 106 for feeding in electrical signals through appropriate insulating feedthroughs, such as a glass or ceramic region. Header 102 also typically includes a region 108 for mounting photonic device 104, sometimes known as a “stem”. For example, if photonic device 104 is an edge-emitting laser, the laser is mounted on the stem using a laser submount. The header includes a baseplate 110 having a comparatively flat annular region that forms a seating surface for bonding a lip region 116 of cap 112 to header 102.

In some applications it is desirable to replace flat window 114 of cap 112 with a micro-lens. The micro-lens can be selected to improve the optical coupling of photonic device 104 in package 100 with an exterior optical element. For example, if photonic device 104 in package 100 is a laser, a micro-lens can be integrated in cap 112 to improve the optical coupling of the laser to an optical fiber, optical waveguide, or other optical device used to transmit the optical signal generated by the laser. However, if a lens is included in the cap, some method must be used to align the lens in the cap to the photonic device inside.

One method of measuring the alignment of the lens in the cap to the photonic device in the header is to measure the concentricity. Concentricity is the measure of the difference between the alignment of the center of the photonic device and the center of the lens. Ideally, the concentricity is zero, thus indicating that the two devices are perfectly aligned. In practice, there is usually some misalignment, however small. Acceptable ranges of concentricity vary according to the specific devices involved, and the uses that are to be made of those devices.

Currently, active alignment processes are used to check the concentricity of the package. In an active alignment process, the output of package 100 is optimized with the photonic device in an active state. For example, if the photonic device is a laser, the light output of the laser is monitored outside of the package (e.g., using an optical detector) and the cap is positioned with actuators until the output of the laser is optimized.

Active alignment techniques also have several drawbacks. First, active alignment is more expensive than desired, in part due to the numerous pieces of equipment required to make the measurements to determine an optimum cap position. Additionally, the mechanical apparatus to position and hold the cap in place during final sealing requires accurate alignment actuators that increase the cost of the system. Moreover, slippage can occur after alignment during final sealing of the cap, resulting in reduced yield.

### BRIEF SUMMARY OF THE INVENTION

What is needed is an accurate, quick and inexpensive device and method for passively checking the concentricity measurement between the lens and the photonic device, thus ensuring accurate alignment. The present invention discloses such a device and method. A package for a photonic device includes a header and a lens cap having an integrated lens. The photonic device is mounted to the header. A display system views the photonic device through the lens of the cap. Using a camera, the alignment between the photonic device and the lens in the cap is measured, by viewing the photonic device and lens from directly above the package.

The present invention allows for a quick and accurate measurement of the concentricity between the lens and the photonic device. The photonic device remains inoperable during the alignment process. This results in reduced packaging costs and higher throughput as compared with conventional active alignment techniques.

Additionally, the alignment measurement uses a comparatively inexpensive apparatus. Many of the individual components of the measurement system, such as movable stages and video display systems, are comparatively low-priced components. Since the measurement technique is passive, the expenses of operating the laser and providing a photo diode or other optical reader to use in the measurement process are eliminated.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a side view of a prior art photonic device package having a header and a cap with a flat window;

FIG. 2A is an exploded side view of an exemplary photonic device package including a header and a cap having an integrated lens, the alignment of which can be measured according to one aspect of the present invention;

FIG. 2B is a top view of the exemplary photonic package of FIG. 2A;

FIG. 3 shows an embodiment of an exemplary system for measuring the alignment of the cap and photonic device, according to one aspect of the present invention; and

FIG. 4 illustrates the exemplary system of FIG. 3 showing the lens and photonic device in alignment according to another aspect of the present invention.

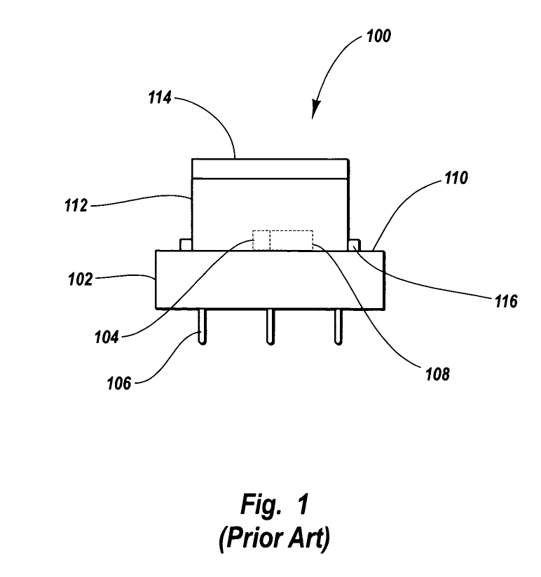

### DETAILED DESCRIPTION OF THE EXEMPLARY EMBODIMENTS

The present invention relates generally to devices, systems, and methods for measuring the alignment of a lens in a lens cap to a photonic device in a photonic device package. The present invention also relates to methods, systems, and devices for measuring the alignment of the photonic device on the header where it is attached. The present invention facilitates reductions in manufacturing costs of photonic device packages by eliminating active testing of the alignment of the components within the packages.

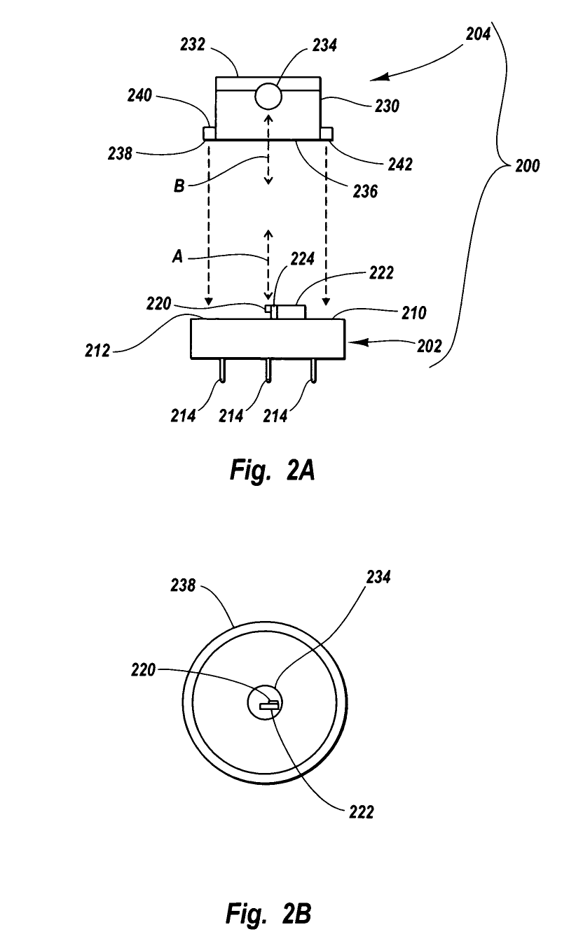

Referring to FIG. 2A, depicted is an exemplary optical package 200 having a header 202 and a cap 204. Header 200 can be a transistor outline package (TO) or a receiver package having a photo detector. In the illustrated configuration, header 202 includes a base plate 210 of a conductive metal that has a region 212 that cooperates with cap 204. Region 212 can include recesses, protrusions, or other structures that aid with positioning cap 204 relative to header 202 and aid with seating cap 204 thereto. In the illustrated configuration of FIGS. 2A and 2B, header 202 is generally circular and so has an annular region 212. One skilled in the art will understand, however, that various other configurations are possible, such as, but not limited to, polygonal, oval, curved, or other configurations so long as base plate 210 of header 202 cooperates with cap 204.

Extending from region 212 and through base plate 210 are feedthroughs 214. Feedthroughs 214 provide electrical connections to the optoelectronic components mounted to header 202, such as, but not limited to a photonic device 220 and/or an associated stem 222. Feedthroughs 214, in one configuration, can be disposed proximate stem 222 in an insulating region (not shown) of header 202.

Mounted to header 202 is stem 222 that receives photonic device 220. Photonic device 220 can be any device that generates or receives light passing through cap 204. An optical axis A of photonic device 220 corresponds to the axis of the emitted beam. This optical axis A is dependent upon whether photonic device 220 either transmits or receives a beam of light. The optical axis A, therefore, is either the optical axis of an emitted beam from photonic device 220 or the optical axis of a beam received by photonic device 220, such as the surface normal of an optical detector. In one embodiment, photonic device 220 is an edge-emitting laser. More generally, however, photonic device 220 can comprise other types of photonic devices, such as a vertical cavity surface emitting laser (VCSEL), an optical detector, a surface-emitting light emitting diode (LED) or an edge-emitting LED.

Disposable upon header 202 is cap 204. The cap 204 includes a body 230 upon which is mounted a window 232 and at least one lens 234. While lens 234 can be part of window 232, an additional window layer can cover lens 234. For example, a layer of an optically transparent medium, such as glass, optical grade plastic, or other suitable optical material may be used. In a packaged device, it is desirable that an optical axis B of lens 234 aligns with optical axis A of photonic device 220, since this improves optical coupling.

Cap 204 has a lip 238 about a bottom receptacle end 236. Lip 238 has an upper lip region 240 and an opposed bottom lip region 242. The lip 238 cooperates with region 210 so that cap 204 mounts to header 202. Various configurations of lip 238, and more generally bottom receptacle end 236 of cap 204, can be used, so long as the structure or configuration is complementary to region 210 of header 202.

Lens 234 of cap 204 can be any suitable micro-lens. Selecting the focal length, numerical aperture, and separation distance with respect to photonic device 220, in accord with conventional principles of optics, optimizes the optical coupling to photonic device 220. However, this optical coupling is dependent upon the lens and photonic device being properly aligned. Photonic device 220 can be a semiconductor laser. With the proper alignment and the optimized separation distance and focus length, the output of the laser can be coupled into an optical fiber with improved coupling efficiency. Alternately, when photonic device 220 is a photodetector or photo diode, the selected focal length, numerical aperture, and separation distance of lens 234 improves optical coupling of the input beam to the photodetector or photo diode when the lens is properly aligned to the photo diode.

Lens 234 can be a ball lens, also sometimes known as a spherical ball micro-lens or a spherical micro-lens. A ball lens can have a diameter between about 1.0 millimeters to 5.0 millimeters. A ball lens can be manufactured from a variety of materials, such as silica, silicon, sapphire or the other type of high index glasses, such as, but not limited to, BK7. The refractive index of a ball lens is typically between about 1.45 to about 3.5. For a particular application, the refractive index and diameter of the ball lens are selected to achieve a desired numerical aperture and focal length of the lens and so may be different than described herein.

Regardless of the specific components used in the header and cap, the lens in the cap and the photonic device mounted on the header are precisely aligned to facilitate data transfer from the optical signal. The optical characteristics of, for example, a laser mounted in a lens cap, depend in part upon the alignment accuracy of the laser to the lens cap. Conventionally, an active alignment process has been used to align the laser to the lens cap prior to hermetic sealing. An active test of the laser may then be used to confirm whether the laser has maintained its alignment during sealing. However, conventional alignment and test methods are more expensive than desired. They are both more time consuming and equipment intensive.

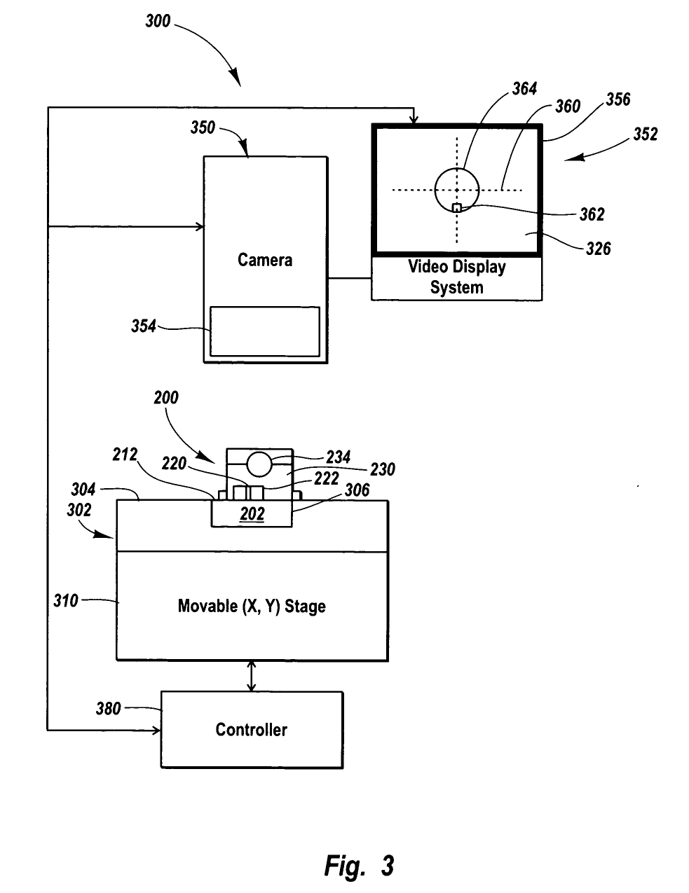

FIG. 3 illustrates one exemplary configuration of a measurement system 300 in accordance with the present invention. Verifying the alignment of lens 234 in cap 204 to photonic device 220 in header 202 is possible using alignment system 300. As illustrated, alignment system 300 includes a capture assembly 302 that receives packaged device 200. This capture assembly 302 includes a chuck 304 and associated locking mechanism (not shown). The chuck 304 includes, in one configuration, appropriately shaped holes or recesses 306 to receive feedthroughs 214 or other electrical pins (see FIG. 2A) of packaged device 200. Chuck 304 engages the bottom and/or sides of base plate 210. Chuck 304 can include one or more pieces to facilitate attaching or mounting of packaged device 200 within recess 306.

A locking mechanism (not shown) cooperates with chuck 304 to lock packaged device 200 within recess 306. The locking mechanism can include pins, screws, latches, levers, gear, or other suitable locking mechanisms that result in mechanical engagement of packaged device 200 with chuck 304 or application of sufficient force upon packaged device 200 to prevent movement of packaged device 200 during the measuring process. In one configuration, the locking mechanism includes a pneumatic locking mechanism as part of chuck 304 that uses air pressure to lock and unlock packaged device 200. Alternatively, hydraulic and/or mechanical locking mechanisms lock and unlock packaged device 200. Similarly, combinations of different types of pneumatic, hydraulic, and/or mechanical locking mechanisms can be used to lock and unlock packaged device 200, whether such locking mechanisms include or exclude chuck 304.

The capture assembly 302 mounts to a movable stage or structure 310. This moveable structure 310 moves capture assembly 302 and hence the supported packaged device 200 during the alignment measuring process using various mechanical, pneumatic, hydraulic, or other devices and structures as known to those skilled in the art. For instance, pneumatic or hydraulic rams can move chuck 304 in the x-direction, y-direction, and/or the z-direction. Although reference is made to movement of chuck 304 in the x-direction, y-direction, and/or the z-direction, one skilled in the art will appreciate that chuck 304 can remain in a constant position, while other components of system 300, such as camera 350, move relative to chuck 304.

To aid with accurately measuring the position or alignment of lens 234 in cap 204 with respect to header 202 and photonic device 220, system 300 includes a camera system 350 and a video display system 352. Camera 350 is disposed above packaged device 200. Any suitable camera having sufficient magnification to view photonic device 220 through lens 234 can function as camera 350. For example, a video camera or a video imaging system with an optional built-in zoom lens 354 can function as camera 350. Alternatively, additional optics (not shown) coupled to camera 350 provide the desired optical magnification. The desired magnification will depend, in part, upon the optical characteristics of lens 234, the separation of camera 350 from lens 234, and the desired alignment accuracy. For example, a camera zoom magnification of about thirty can be sufficient because ball lens 234 increases the effective magnification of the combined zoom lens/ball lens system.

Camera 350 provides a video input to video display system 352 having a video monitor 356 and control electronics (not shown). The focus of camera 350 permits simultaneous imaging of photonic device 220 and the outline of lens 234. For a ball lens, lens 234 appears as a circular-shaped region and has an optical axis disposed at its center. Photonic device 220 typically has a rectangular-shape associated with its die.

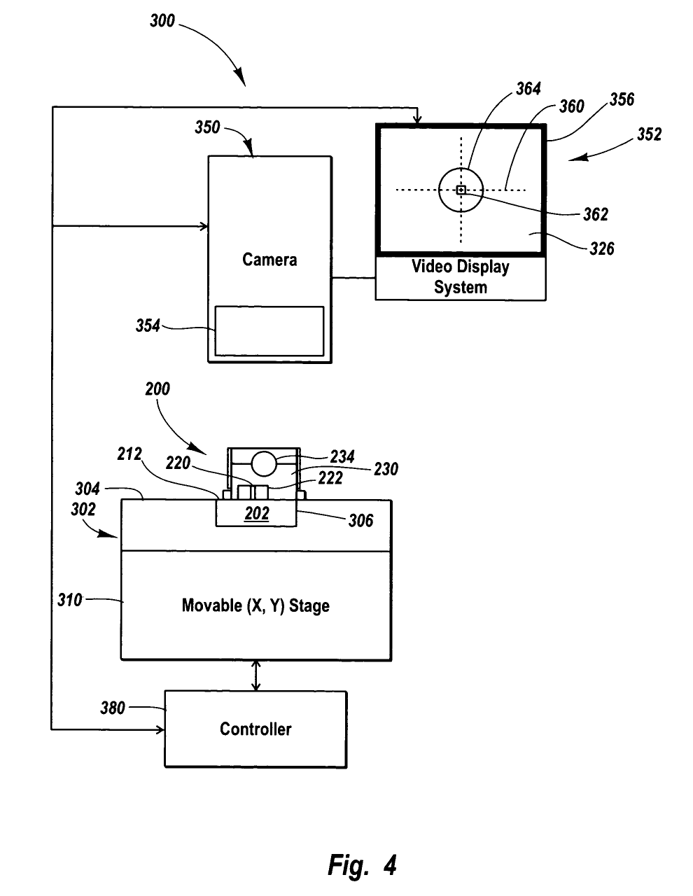

Video display system 352 also includes a video calibration pattern/reticule 360 that can be superimposed, such as a calibrated circle or cross-hairs, to determine the concentricity of an image 362 of photonic device 220 relative to an image 364 of lens 234. The calibration pattern 360 includes an indicator of a pre-selected maximum concentricity distance between the center of lens 234 and photonic device 220. The maximum concentricity, for example, can be determined from principles of optics or by performing calibration tests. For a laser transmitter with a ball lens in the cap, acceptable range for concentricity should be about less than 50 microns or some other range depending on the applications. The system as described can measure a concentricity to about 1 micron. A suitable keyboard or control knobs can be used to adjust the position of the superimposed video pattern. An example of the lens 234 is properly aligned to the photonic device 220 is shown in FIG. 4.

Devices that exceed the maximum concentricity should be rejected. Co-pending and co-owned U.S. Utility patent application Ser. No. 60/422,069, filed on October 28, 2002, and entitled “Photonic Device Package with Aligned Lens Cap”, outlines an apparatus and method for achieving a more precise alignment for lens 234 in cap 204 to photonic device 220 in header 202. It is understood by those of skill in the art that packaged device 200 is shown in detail for illustration purposes only. The concentricity of any packaged device having an internal photonic device covered by a cap with a lens can be measured using the apparatus and techniques of the present invention.

In an alternative embodiment of the present invention, the concentricity of photonic device 220 with respect to header 202 can be measured prior to positioning and sealing cap 204 onto header 202. If photonic device 220 is not relatively centered onto header 202, lens 234 in cap 204 will not align properly with photonic device 220. Verifying that photonic device 220 is centered on header 202 prior to installation and sealing of cap 204 onto header 202 can save both time and money. Packaged device 200 will not function properly if the concentricity of the optical components is too far off.

A control system 380 controls the operation or functions of one or more of the systems or devices system 300. In one configuration, control system 380 moves stage 310 relative to camera 350. For example, control system 380 can include (x, y, and z) control knobs enabling an operator to move stage 310 relative to camera 350. In another configuration, control system 380 manages movement of camera 350 and presentation of images using video display system 352. It will be understood by one skilled in the art that control system 380 can perform one or more of the above functions under the control of one or more programs or software applications stored at control system 380.

While the present invention has been described in detail in regards to a lens cap having a single lens, it will be understood that the present invention can also be applied to a cap having an optical assembly including more than one lens. Additionally, it will be understood, therefore, that the single lens can be replaced by an optical lens assembly that can include additional optical components (e.g., an optical isolator). As long as there is a clear optical path between the zoom lens of the camera and lens and photonic device system of the packaged device, the invention can be used to measure the concentricity.

Further, the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to measure a concentricity of optical components in an optical assembly, said optical assembly comprising a header with a photonic device mounted thereon, said photonic device having a first optical axis, said optical assembly further comprising a cap having a lens therein, said lens having a second optical axis, the apparatus comprising:
a chuck configured to support said optical assembly, said chuck being adapted to support said optical assembly without obstructing a view of at least a portion of said lens; and
a visual display system adapted to depict a position of said lens relative to said photonic device and to measure said position.

2. The apparatus of claim 1, wherein said measurement is used to determine said concentricity between said first optical axis and said second optical axis.

3. The apparatus of claim 1, wherein said visual display system comprises at least one camera and at least one video display.

4. The apparatus of claim 3, wherein said camera further comprises a zoom lens.

5. The apparatus of claim 3, wherein said visual display system includes a video overlay including at least one calibration feature that allows said concentricity to be measured.

6. The apparatus of claim 5, wherein said calibration feature allows said concentricity to be measured to within 1 micron.

7. The apparatus of claim 1, wherein said lens is a ball lens and said photonic device is a laser.

8. The apparatus of claim 7, wherein said first optical axis is collinear with a beam emitted from said laser.

9. The apparatus of claim 7, wherein said second optical axis passes through a center of said ball lens.

10. The apparatus of claim 1, wherein said visual display system is movable relative to said chuck.

11. The apparatus of claim 1, wherein said chuck is movable relative to said visual display system.

12. A method for measuring a concentricity of optical components in an optical assembly comprising:
a step for providing an optical assembly, said optical assembly having at least one component mounted on a base;
a step for mounting said optical assembly in a chuck;
a step for measuring said concentricity of said component relative to said base using a visual display system.

13. The method of claim 12, wherein said visual display system comprises at least one camera and at least one video display.

14. The method of claim 13, wherein said camera further comprises a zoom lens.

15. The method of claim 13, wherein said component is a laser having a first axis and said base is a header having a second axis parallel to said first axis, and wherein the step for measuring measures the distance between said first axis and said second axis.

16. The method of claim 13, wherein said visual display system includes a video overlay including at least one calibration feature that allows said concentricity to be measured.

17. The method of claim 16, wherein said calibration feature allows said concentricity to be measured to within 1 micron.

18. A method for measuring a concentricity of optical components in an optical assembly, said optical assembly comprising a header with a photonic device mounted thereon, said photonic device having a first optical axis, and a cap having a lens therein, said lens having a second optical axis, said method comprising:
a step for viewing said photonic device through said lens;
a step for measuring a distance between said first optical axis and said second optical axis.

19. The method of claim 18, wherein said step for viewing comprises a step for viewing said photonic device by a video display system.

20. The method of claim 19, wherein said video display system comprises at least one camera and at least one video display.

21. The method of claim 20, wherein said camera further comprises a zoom lens.

22. The method of claim 20, further comprising a step for overlaying a calibration pattern on said video display.

23. The method of claim 22, wherein said calibration pattern allows said distance to be measured to within 1 micron.

24. The method of claim 18, wherein said lens is a ball lens and said photonic device is a laser.

25. The method of claim 24, wherein said first optical axis is collinear with a beam emitted from said laser.

26. The method of claim 25, wherein said second optical axis passes through a center of said ball lens.

27. The method of claim 18, wherein said optical assembly is held in an arm and said visual display system is movable relative to said arm.

28. The method of claim 18, wherein said optical assembly is held in an arm and said arm is movable relative to said visual display system.
